(19) United States
(12) Patent Application Publication
(10) Pub. No.: US 2012/0173713 A1
(43) Pub. Date: Jul. 5, 2012

(54) RESOURCES MONITORING AND RECOVERY

(75) Inventors: Bei Wang, Palo Alto, CA (US); Xiaohui Lu, Fremont, CA (US); Peiming James Chen, San Jose, CA (US)

(73) Assignee: Brocade Communication Systems, Inc., San Jose, CA (US)

(21) Appl. No.: 13/235,245

(22) Filed: Sep. 16, 2011

Related U.S. Application Data
(60) Provisional application No. 61/428,679, filed on Dec. 30, 2010.

(51) Int. Cl. G06F 15/173

(52) U.S. Cl. 709/224

(57) ABSTRACT

Techniques for monitoring system resources such that a resource-related problem can be identified at a point in time when it is still possible to initiate a set of recovery actions for remedying the problem without disrupting services provided by the system. Various system resources may be monitored including but not limited to system memory (e.g., RAM), one or more processors, non-volatile memory (e.g., Compact Flash usage), and the like.

### CROSS-REFERENCES TO RELATED APPLICATIONS

The present application is a non-provisional of and claims the benefit and priority under 35 U.S.C. 119(e) of U.S. Provisional Application No. 61/428,679 filed Dec. 30, 2010, entitled RESOURCES MONITORING AND RECOVERY, the entire contents of which are incorporated herein by reference for all purposes.

### BACKGROUND

Embodiments of the present invention relate to monitoring of resources. More particularly, techniques are provided for monitoring resources in a system such that any resource-related problem can be identified at a point in time when it is still possible to initiate a set of recovery actions for remedying the problem without disrupting services provided by the system.

Achieving high-availability is an important goal for any network device vendor or manufacturer. In an effort to achieve high availability, network device designers strive to reduce events that can disrupt networking services (e.g., L2 services) provided by the network devices. For example, several network devices now provide redundant control processors operating in an active-standby model to reduce disruption of services. According to the active-standby model, at any time one control processor is configured to operate in active mode performing the various functions associated with the network device, while the other control processor operates in standby mode. Essential information and data structures that are necessary for continuing the operations of the network device may be synchronized to the standby processor such that, when a failover or switchover occurs, the standby processor becomes the active processor and takes over processing from the previous active processor. In this manner, the network device continues to provide services without any or substantial interruption. A failover may be performed voluntarily, such as when a firmware upgrade is to be performed, or may occur involuntarily such as due to possible problems in the working of the active processor. One such failover process is described in U.S. Pat. No. 7,188,237 assigned to Brocade Communication Systems, Inc.

High-availability mechanisms are not restricted to network devices with multiple control processors. For example, U.S. Pat. No. 7,188,237 also describes a technique for changing the firmware in a single control processor network device without disrupting the services provided by the network device.

In spite of presently available high-availability measures such as those discussed above, there continue to be several conditions that occur in a network device that cause services provided by the network device to be disrupted. One such common condition is when the network device experiences an out-of-memory condition, when there is insufficient memory to continue proper processing. The out-of-memory condition may be caused by various reasons such as memory leaks due to buggy software, and others. When such a condition occurs, it is generally too late to run any recovery action since the recovery actions themselves are memory intensive and there is not enough system memory available to successfully perform the actions without system disruption. As a result, presently, actions that are performed to recover from out-of-memory conditions all cause a disruption in services provided by the network device.

### BRIEF SUMMARY

Embodiments of the present invention provide techniques for monitoring system resources such that a resource-related problem can be identified at a point in time when it is still possible to initiate a set of recovery actions for remedying the problem without disrupting services provided by the system. Various system resources may be monitored including but not limited to system memory (e.g., RAM), one or more processors, non-volatile memory (e.g., Compact Flash usage), and the like.

According to an embodiment of the present invention, a system or device may comprise one or more memory-related or processing-related resources. The system/device may be configured to detect the presence of a condition related to a resource of the system, which could potentially, if not corrected, lead to a disruption in services provided by the system or device. Upon detecting such a condition, the system may be configured to take one or more recovery actions to remedy the detected condition.

For example, in one embodiment, a system may comprise a resource and a processor that is configured to, upon detecting the presence of a condition related to the resource, release a portion of memory and use the released portion of memory to execute an action that remedies the detected condition. The resource may be a memory-related resource or a processing-related resource of the system.

In one embodiment, a system or device, such as a network device, may be configured to reserve a portion of volatile memory of the network device. The network device may monitor a set of one or more parameters related to a resource of the network device. Based upon the monitored one or more parameters, the network device may determine whether a condition related to the resource exists. Upon determining that the condition exists, the network device may be configured to release a section of the reserved portion of memory and initiate an action that uses the released section of memory. The action may be such that it remedies the detected condition.

The network device may use various techniques to determine if the condition related to the resource exists. For example, in one embodiment, the network device may compare a value associated with a parameter in the set of parameters to a preconfigured threshold and determine that the condition exists if the value associated with the parameter in the set of parameters equals or exceeds the preconfigured threshold value. In another embodiment, the network device may determine that the condition exists if the value associated with the parameter in the set of parameters equals or is less than the preconfigured threshold value.

Various different resources may be monitored including memory-related resources, processing-related resources, and others. In one embodiment, the resource being monitored may be the volatile memory (e.g., RAM) of the system. In such an embodiment, the set of parameters may comprise volatile memory-related parameters such as a parameter indicative of a size of the reserved portion of the volatile memory, a parameter indicative of a size of free memory available in the volatile memory, and the like.

In another embodiment, the resource being monitored may be a non-volatile memory of the network device. An example of such a resource is Compact Flash used by the system. In yet another embodiment, processing-related resources may be monitored such as the usage of a processor of a system or device may be monitored. In this embodiment, the set of parameters may comprise parameters related to the processor such as usage levels of the processor, and the like.

Various different recovery actions may be initiated in response to detection of a condition related to a resource. In one embodiment, these actions are initiated to remedy the detected condition. For example, in a network device operating according to an active-standby model wherein, at any time, one processor of the network device operates in active mode and the other processor operates in standby mode, the recovery action that is initiated may be one that causes a failover or switchover to occur. As a result of such an action, the previously standby processor becomes the active processor and the previously active processor becomes the standby processor.

The foregoing, together with other features and embodiments, will become more apparent when referring to the following specification, claims, and accompanying drawings.

### BRIEF DESCRIPTION OF THE DRAWINGS

FIG. 1 is a simplified block diagram of a network device that may incorporate an embodiment of the present invention;

FIG. 2 depicts a simplified flowchart depicting system memory-related processing performed according to an embodiment of the present invention;

FIG. 3 is a simplified block diagram of a network device 300 comprising multiple control processors according to an embodiment of the present invention; and

FIGS. 4, 5, 6, and 7 depict CPU-usage parameters and thresholds that may be used according to an embodiment of the present invention.

### DETAILED DESCRIPTION

In the following description, for the purposes of explanation, specific details are set forth in order to provide a thorough understanding of embodiments of the invention. However, it will be apparent that the invention may be practiced without these specific details.

Embodiments of the present invention provide techniques for monitoring system resources such that a resource-related problem can be identified at a point in time when it is still possible to initiate a set of recovery actions for remedying the problem without disrupting services provided by the system. The resources that are monitored may be of various types. For example, in one embodiment, the resource may be a memory-related resource such as system memory (e.g., RAM), non-volatile memory (e.g., Compact Flash), and the like. In another embodiment, the resource may be a processing-related resource such as one or more processors of a system or device.

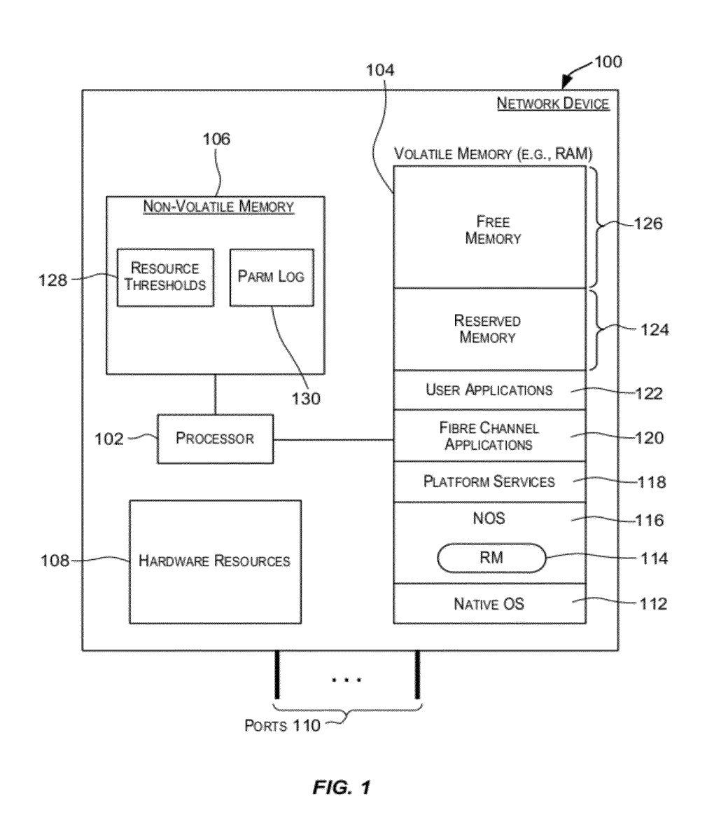

FIG. 1 is a simplified block diagram of a network device 100 that may incorporate an embodiment of the present invention. Examples of a network device include but are not limited to a switch, a router, or any other device that facilitates forwarding of data. For example, network device 100 may be a Fibre Channel or Ethernet switch or router provided by Brocade Communications Systems, Inc. of San Jose, Calif. The components of network device 100 depicted in FIG. 1 are meant for illustrative purposes only and are not intended to limit the scope of the invention in any manner. Alternative embodiments may have more or fewer components than those shown in FIG. 1.

Network device 100 may be configured to receive and forward data. Network device 100 may support various different communication protocols for receiving and/or forwarding data including Fibre Channel technology protocols, Ethernet-based protocols (e.g., gigabit Ethernet protocols), Transmission Control/Internet Protocol-based protocols, and others. The communication protocols may include wired and/or wireless protocols.

In the embodiment depicted in FIG. 1, network device 100 comprises a single control processor 102 with associated volatile memory 104, non-volatile memory 106, hardware resources 108, and one or more ports 110. Ports 110 represent the input/output plane of network device 100. Network device 100 may receive and forward data (e.g., packets) using ports 110. A port within ports 110 may be classified as an input port or an output port depending upon whether network device 100 receives or transmits a packet using the port. A port over which a packet is received by network device 100 is referred to as an input port. A port used for communicating or forwarding a packet from network device 100 is referred to as an output port. A particular port may function both as an input port and an output port. A port may be connected by a link or interface to a neighboring network device or network. Ports 110 may be capable of receiving and/or transmitting different types of data traffic at different speeds including 1 Gigabit/sec, 10 Gigabits/sec, 40 Gigabits/sec, 100 Gigabits/sec, or more or less speeds. In some embodiments, multiple ports of may be logically grouped into one or more trunks.

In the embodiment shown in FIG. 1, network device 100 comprises a single control processor 102. Processor 102 is configured to execute software that controls the operations of network device 100 and facilitates networking services (e.g., L2 services) provided by network device 100. Processor 102 may be a CPU such as a PowerPC, Intel, AMD, or ARM microprocessor, operating under the control of software. The programs/code/instructions that are executed by processor 102 may be loaded into volatile memory 104 and then executed by processor 102. Volatile memory 104 is typically a random access memory (RAM) and is often referred to as system memory.

Non-volatile memory 106 may be of different types including a Compact Flash (CF), a hard disk, an optical disk, and the like. Information that is to be persisted may be stored in non-volatile memory 106. Additionally, non-volatile memory 106 may also store programs/code/instructions that are to be executed by processor 102 and also any related data constructs.

Network device 100 may also comprise one or more hardware resources 108. These hardware resources may include, for example, resources that facilitate data forwarding functions performed by network device 100. Hardware resources 108 may also include one or more devices associated with network device 100.

Various software components may be loaded into RAM 104 and executed by processor 102. These software components may include, for example, an operating system or kernel 112 (referred to henceforth as the “native operating system” to differentiate it from network operating system (NOS) 116). Native operating system 112 is generally a commercially available operating system such as Linux, Unix, Windows OS, a variant of the aforementioned operating systems, or other operating system.

A network operating system (NOS) 116 may also be loaded. Examples of a NOS include Fibre Channel operating system (FOS) provided by Brocade Communications Systems, Inc. for their Fibre Channel devices, JUNOS provided by Juniper Networks for their routers and switches, Cisco Internetwork Operating System (Cisco IOS) provided by Cisco Systems on their devices, and others. In one embodiment, NOS 116 provides the foundation and support for networking services provided by network device 100. For example, a FOS loaded on a Fibre Channel switch enables Fibre Channel-related services such as support for Fibre Channel protocol interfaces, management of hardware resources for Fibre Channel, and the like.

Other software components that may be loaded in RAM 104 (as shown in the embodiment depicted in FIG. 1) include a platform services component 118, Fibre Channel applications 120, and user applications 122. Platform services component 118 may, for example, comprise logic and support for blade-level management in a chassis-based network device with multiple blades, chassis environment setup, power supply management, messaging services, daemons support, support for command line interfaces (CLIs), and the like.

The software components depicted in FIG. 1 are examples and not intended to limit the scope of embodiments of the present invention. Various other software components not shown in FIG. 1 or a subset thereof may also be loaded in alternative embodiments.

In one embodiment, NOS 116 comprises a specialized software component called a resource monitor (RM) 114 that comprises logic and instructions/code, which when executed by processor 102, causes resources-related processing, as described herein, to be performed. In one embodiment, the resources-related processing comprises monitoring one or more resources of network device 100 such that a resource-related problem can be identified at a point in time when it is still possible to initiate a set of recovery actions to remedy the problem without substantially disrupting services provided by the network device based upon that resource. Upon detecting a resource-related problem, RM 114 may initiate one or more recovery actions to recover from the problem. In one embodiment, the recovery actions are performed without disrupting or without substantially disrupting networking services (e.g., L2 services, L3 services, etc.) provided by network device 100.

In the embodiment depicted in FIG. 1, RM 114 is shown as a part of NOS 116. However, in alternative embodiments, RM 114 may be provided separately from NOS 116. For example, in one embodiment, RM 114 may be loaded as a software component after NOS 116 has been loaded into RAM 104.

As discussed above, in one embodiment, RM 114 is configured to monitor one or more resources of network device 100. Various different network device resources may be monitored by RM 114 including but not limited to system memory (i.e., RAM 104), non-volatile memory 106 or portions thereof, CPU usage of processor 102, utilization of hardware resources 108, and the like. An embodiment is described below in which system memory (RAM 104) is monitored. Embodiments of the present invention are however not restricted to system memory monitoring; other system resources may also be monitored and appropriate recovery actions initiated upon detecting a resource-related problem.

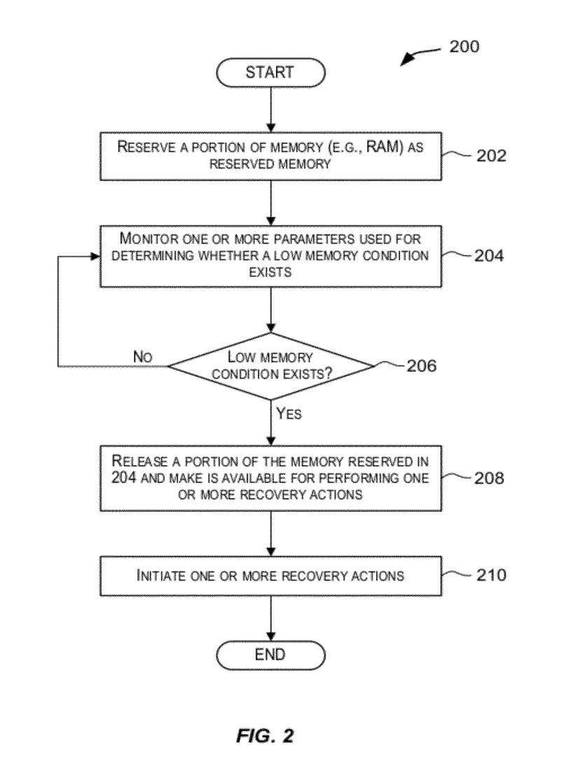

FIG. 2 depicts a simplified flowchart 200 depicting processing performed according to an embodiment of the present invention. The embodiment depicted in FIG. 2 performs processing for monitoring system memory (e.g., RAM). The processing depicted in FIG. 2 may be performed using software (e.g., code, instructions, program) executed by processor 102, in hardware, or combinations thereof. In one embodiment, the processing may be performed upon execution of code/logic included in RM 114. The software may be stored on a non-transitory computer-readable storage medium and may be executed by a processor. The particular series of processing steps depicted in FIG. 2 is not intended to limit the scope of embodiments of the present invention.

As depicted in FIG. 2, a portion 124 of RAM 104 is reserved (step 202). The reserved memory 124 represents memory that has been allocated but is not used. This is to be differentiated from free memory 126 that represents unallocated unused memory. There are various different ways in which this memory may be reserved. In one embodiment, one or more idle processes may be used to reserve the memory. For example, a process may be created and the memory to be reserved allocated to that process. The process may then be put in idle state.

In one embodiment, the amount of memory 124 that is reserved in 202 is such that it is sufficient to successfully perform one or more recovery actions that are to be initiated when a system memory-related problem (e.g., a low memory condition) is deemed to exist. Generally, the one or more recovery actions that are performed in 210 are known in advance, and consequently, the amount of memory required for successfully completing these recovery actions is also known and reserved in 202.

Accordingly, a size of memory sufficient to recover from a system memory-related problem is reserved in 202. In one embodiment, the size of system memory that is reserved is sufficient to perform one or more recovery actions that are initiated upon detecting a system memory-related problem to resolve the problem.

In one embodiment, the size of memory to be reserved may be specified as an absolute value, such as 20 MB of RAM 104 may be reserved in 202. In another embodiment, the size of system memory to be reserved may be determined as a percentage of the total system memory size or total free memory 126. For example, in one embodiment, 10-15% of the total RAM 104 memory may be reserved in 202. The amount of memory to be reserved in 202 may be user-configurable.

One or more system memory-related (or resource-related in general) parameters are monitored (step 204). In one embodiment, as part of 204, those parameters are monitored in 204 that are sufficient to determine whether a specific resource-related condition exists. In FIG. 2, the resource-related condition is a low system memory condition and accordingly one or more system memory-related parameters that are sufficient for detecting this condition are monitored in 204. Other types of resource-related conditions may be monitored in alternative embodiments and in these alternative embodiments, the one or more resource-related parameters that are monitored in 204 may depend upon the particular resource-related condition(s) being monitored.

Information related to the monitored parameters may be stored in non-volatile memory 106. For example, parameters-related information may be stored in non-volatile memory 106 as parameter log 130. In one embodiment, the monitored data is stored in a trace file. The trace file may be used for online and post failure analysis.

Based upon the parameters monitored in 204, a determination is made whether the condition being checked for exists (step 206). The condition being checked for in 206 typically indicates the presence of a resource-related problem for which corrective action(s) is to be taken. In the embodiment depicted in FIG. 2, a determination is made whether a low system memory condition exists. In alternate embodiments, other types of resource-related conditions may be checked for.

The reason for monitoring resource-related parameters in 204 network device to check for a resource-related condition in 206 is to enable a resource-related problem to be identified early enough at a point in time when it is still possible to initiate one or more actions to recover from the problem without disrupting services provided by network device 100. For example, with respect to system memory-related monitoring shown in FIG. 2, the goal of the processing performed in 204 and 206 is to identify when system memory is running low (referred to as a low memory condition) before the condition progresses to a potentially non-recoverable out-of-memory situation.

The test for when a low memory condition exists is user-configurable and may depend upon the configuration of the network device. The parameters related to system memory that are monitored in 204 are also user configurable. The test for a low memory condition may be configured such that when the test is met, it signals a low memory condition and identifies a time for initiating one or more recovery actions related to the system memory.

The test for a resource-related condition, such as the test for a low system memory condition, may be based upon one or more resource-related parameters monitored in 204. In one embodiment, the test for a low memory condition may be configured upon one or more of the following RAM-related parameters, which may be monitored in 204:
(a) the size of reserved memory 124
(b) the size of free memory 126
(c) the size of reserved memory 124 plus the size of free memory 126.

The following Table A gives examples of tests that may be configured to determine whether a low memory condition exists in various embodiments.

TABLE A
Examples of tests for a “low memory” condition

| Example tests for when a Low Memory | |
|---|---|
| Condition exists | Description |
| (1) Low memory (LM) condition exists if the | For this test, the size of reserved memory 124 |
| ratio of the size of free memory 126 to the size | and free memory 126 may be monitored in |
| of reserved memory 124 falls below a | 204. |
| threshold T1. | |
| (2) LM condition exists if the size of free | Threshold T2 may be expressed as an absolute |
| memory 126 falls below a threshold T2. | value (e.g., 20 MB) or as a relative value (e.g., |
| | a % of the total size of RAM 104). Given this |
| | test, the size of free memory 126 may be |
| | monitored in 204. |
| (3) LM condition exists if the size of free | Threshold T3 may be expressed as an absolute |
| memory 126 plus the size of reserved memory | value (e.g., 20 MB) or as a relative value (e.g., |
| 124 falls below a threshold T3. | a % of the total size of RAM 104). Given this |
| | test, both the size of free memory 126 and the |
| | size of reserved memory 124 may be |
| | monitored in 204. |

Accordingly, there are different ways in which a test for a “low memory” condition may be configured for network device 100. Table A is not meant to be exhaustive and/or limit the different ways in which a low memory condition test may be specified. The test for a low memory condition may vary from one network device to another based upon the configuration of the network device, per user needs/requirements, and the like.

The thresholds (e.g., T1, T2, and T3, etc. in Table A) that are set may be different for different resources. The threshold may also be set differently for different devices and/or for different platforms. For example, if free memory usage is being monitored, then the threshold configured for one system may be the same as or different from a threshold configured for another system.

In one embodiment, information related to the test for when a low memory condition exists may be stored in non-volatile memory 106 as resource threshold information 128. If multiple resources are being monitored, information 128 may store information (e.g., tests and thresholds information) related to a test for each resource for identifying problems associated with that resource.

Referring back to FIG. 2, if it is determined in 206 that a low memory condition does not exist, then processing continues with the monitoring in 204. If it is determined in 206 that a low memory condition exists, then a portion of reserved memory 124 is freed and made available for one or more recovery actions to be performed (step 208). In one embodiment, a portion of the reserved memory sufficient for successfully completing the recovery actions may be released. As previously discussed, typically, the one or more recovery actions to be performed are user-configured and known in advance, and as a result the amount of memory needed to complete these actions and to be released in 208 is also known. In another embodiment, all the reserved memory may be released in 208 and made available to the recovery actions.

One or more recovery actions are then initiated (step 210). The recovery actions may use portions of the reserved memory released in 208. Various different recovery actions may be initiated that can remedy the low system memory condition without disrupting services provided by network device 100. For example, in one embodiment, for a network device such as network device 100 having a single processor 102, the recovery action may include rebooting processor 102. In another embodiment, the action may include performing a firmware load (or hot code load), as described in U.S. Pat. No. 7,188,237 (assigned to Brocade Communication Systems, Inc.), the entire contents of which are incorporated herein by reference for all purposes. The firmware load causes processor 102 to be rebooted, which causes a cleaning out and reloading of software components in RAM 104, and due to the reboot the memory condition that triggered the recovery actions may be remedied. After the reboot, a portion of RAM 104 may be reserved as reserved memory 124 per step 202 and monitoring of memory-related parameters may be resumed as shown in FIG. 2 and discussed above. Other recovery actions may also be performed in alternative embodiments. The actions that are performed may depend upon whether the system has a single CPU or multiple CPUS, single processing core or multiple processing cores, and the like.

The scope and nature of the recovery actions that are performed in 210 may depend upon the resource being monitored (i.e., may be resource specific) and/or on the resource-related problem being alleviated. The actions may also depend upon the configuration and platform of network device 100. Different recovery actions may be performed in different network devices. For example, for the same low memory condition, a first recovery action may be executed in a first network device while a second recovery action, different from the first recovery action, may be performed in a second network device. Accordingly, the recovery actions to be performed in 210 may be customized for a network device. The actions to be performed may also be customized per the network device user's needs/requirements.

In the processing depicted in FIG. 2 and discussed above, reserving a portion of system memory (in step 202) and then making it available (in step 208) for performing recovery actions (in step 210) ensures that the system comprises sufficient system memory for executing the recovery action(s) without disrupting services provided by the network device. This eliminates the need to kill other, possibly critical, processes/applications just for the purposes of freeing memory for performing recovery actions. This in turn ensures that networking services provided by the network device are not disrupted as a result of the recovery actions while at the same time ensuring that the low memory condition is remedied. The technique described above thus provides a way for recovering from resource-related problems while not disrupting services provided by the network device. This results in increased availability of network device 100.

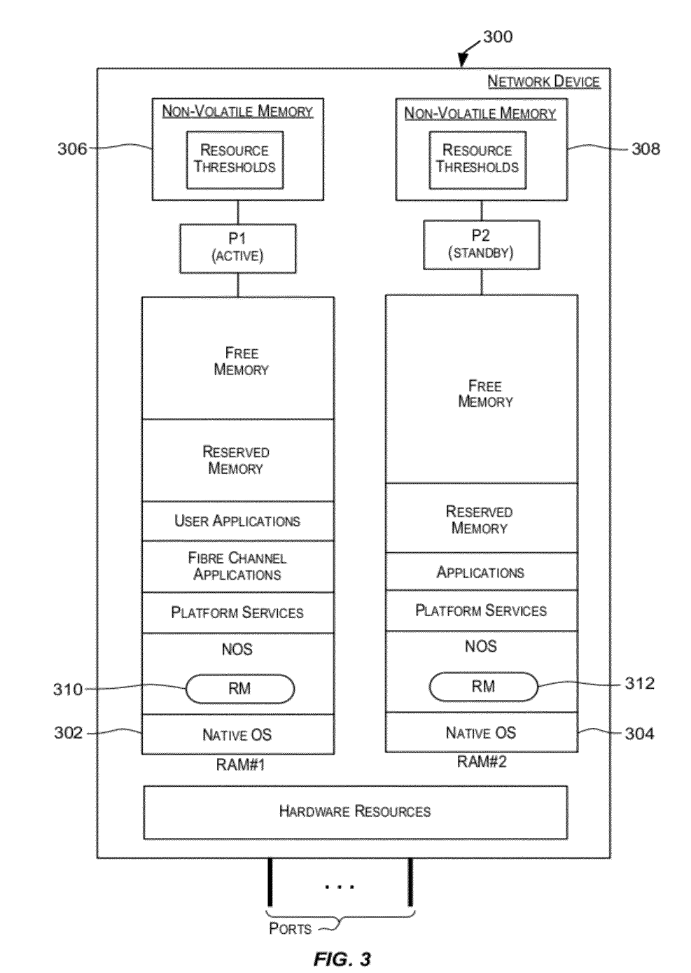

The network device depicted in FIG. 1 and described above comprised a single processor. The resource monitoring and recovery techniques described above may also be applied to a network device comprising multiple processors or processors with multiple cores. FIG. 3 is a simplified block diagram of a network device 300 comprising multiple control processors according to an embodiment of the present invention. Examples of network device 300 include network devices provided by Brocade Communications Systems, Inc. of San Jose, Calif. The components of network device 300 depicted in FIG. 3 are meant for illustrative purposes only and are not intended to limit the scope of the invention in any manner. Alternative embodiments may have more or fewer components than those shown in FIG. 3.

As shown in FIG. 3, network device 300 comprises two control processors P1 and P2. Each processor has its own volatile memory (e.g., RAM) and non-volatile memory. For example, in FIG. 3, processor P1 is coupled with volatile memory 302 (RAM #1) and non-volatile memory 306 and processor P2 is coupled with volatile memory 304 (RAM #2) and non-volatile memory 308. Processors P1 and P2 may be general purpose microprocessors or CPUs such as PowerPC, Intel, AMD, or ARM microprocessors, operating under the control of software stored in an associated memory. The memories associated with a processor may store various programs/code/instructions and data constructs, which when executed by the processor, cause execution of functions that are responsible for facilitating networking services provided by network device 300.

In one embodiment, an active-standby model may be used for operating network device 300. During normal operation of network device 300, one of the two processors operates in active mode while the other processor operates in standby mode. The processor operating in active mode is referred to as the active processor (AP) and is responsible for controlling hardware resources of the network device and also for performing and controlling various functions performed by network device 300. The processor operating in standby mode is referred to as the standby processor and performs a reduced set of functions. Typically, several functions performed by the active processor are not performed by the standby processor. Some information and data structures that are necessary for continuing the operations of the network device may be synchronized to the standby processor such that when the standby processor becomes the active processor the transition can be performed with minimal, if any, disruption to services provided by the network device.

Upon the occurrence of an event such as a failover (or switchover), the standby processor becomes the active processor and takes over performance of functions from the previous active processor. For example, the new active processor may take over management of hardware resources from the previously active processor and also take over performance of functions that were previously performed by the processor that was previously active. The transition from a previous active processor to the new active processor may be performed without interrupting or disrupting the network services provided by network device 300. In this manner, the active-standby model reduces the downtime of network device 300 and thereby increases its availability. The previous active processor may become the standby processor after a failover.

In the embodiment depicted in FIG. 3, processor P1 is shown as the active processor and processor P2 is the standby processor. Upon a failover, P2 will become the new active processor and P1 may become the standby processor.

Conceptually, when operating in active mode the active processor performs a set of functions that are not performed by the standby processor. This set of functions may include networking-related functions, hardware resources management functions, and others that facilitate the network services provided by network device 300. When an event such as a failover or switchover occurs, it causes the standby processor to become the active processor and take over performance of the set of functions from the previous active processor. The previous active processor may then operate in standby mode. The active-standby model thus enables the set of functions to be performed without any interruption, which in turns ensures that the network services provided by network device 300 are not interrupted. This translates to higher availability for network device 300.

A failover or switchover may be caused by various different events, including anticipated or voluntary events and unanticipated or involuntary events. A voluntary or anticipated event is typically a voluntary user-initiated event that is intended to cause the active processor to voluntarily yield control to the standby processor. There are various situations when a network administrator may cause a failover/switchover to occur on purpose, such as when software/firmware on the processors is to be upgraded to a newer version. In this case, the network administrator may voluntarily issue a command that causes a failover/switchover to occur. An involuntary or unanticipated failover/switchover may occur due to some critical failure (e.g., an error caused by software executed by the active processor, failure in the operating system or NOS loaded by the active processor, hardware-related errors on the active processor or other network device component, and the like) in the active processor.

In one embodiment, the processing depicted in FIG. 2 and described above may be performed independently for each of processors P1 and P2 and their associated resources. As depicted in FIG. 3, a resource monitor (RM) component may be loaded into the RAMs associated with each of processors P1 and P2. For example, RM 310 may be loaded into RAM #1 associated with P1 and when executed by processor P1 may cause resource monitoring and recovery processing to be performed for P1 and its associated resources such as for system memory RAM #1 associated with P1. Likewise, RM 312 may be loaded into RAM #2 associated with P2 and when executed by processor P2 may cause resource monitoring and recovery processing to be performed for P2 and its associated resources such as for system memory RAM #2 associated with P2. Accordingly, the processing depicted in FIG. 2 and described above may be performed separately and independently for each of the processors and their associated resources (e.g., system memories).

As previously discussed with respect to FIG. 2, in 206, a test may be performed to detect the presence of a resource-related condition. For example, a test may be performed to determine if a low system memory condition exists. In a multiple processor system, these tests may be performed for each processor and its associated resources independent of the other processors. The test performed for one processor may be the same as or different from the test performed for another processor. For example, for the embodiment depicted in FIG. 3, the test for determining whether a low system memory condition exists may be the same for P1 and P2 or may be different. In one embodiment, two different low memory tests may be configured for a system, one to be used for a processor operating in active mode and the other to be used for a processor operating in standby mode.

One or more recovery actions may be initiated when a low memory condition is detected for a processor. In one embodiment, the recovery action that is performed for a processor may depend upon whether the processor is operating in active mode or standby mode. For example, in one embodiment, for a processor operating in active mode, the recovery action that is performed upon determining a low system memory condition may comprise performing a switchover or failover. As a result of the failover or switchover, the standby processor (i.e., the other processor) becomes the active processor and the previously active processor becomes the standby processor. Also as part of the switchover, the new standby processor is rebooted, which may remedy the low memory condition detected for system memory associated with that processor. Since a failover/switchover can be performed without disrupting the networking services provided by the network device, the low memory condition can be recovered from without disrupting the services provided by the network device.

In another embodiment, for a processor operating in standby mode, the recovery action that is performed upon determining a low memory condition for system memory (e.g., RAM) associated with that processor may comprise performing a reboot for that processor. As part of the reboot, the software components (e.g., the native operating system, the NOS, etc.) may be reloaded in the RAM associated with the standby processor. This rebooting may remedy the low memory condition for the processor. Rebooting a standby processor does not affect the active processor and so the low memory condition is remedied without disrupting the networking services provided by the network device.

In the manner described above, resources of a network device may be monitored and recovery actions initiated for resolving resource-related problems, all without disrupting the network services (e.g., L2 services) provided by the network device. The processing described above may be performed in network devices comprising a single processor and/or in network devices comprising multiple processors or multicore processors.

Various different network device resources may be monitored. While embodiments have been described above for monitoring system memory (e.g., volatile RAM) and taking appropriate recovery actions upon detecting a low memory condition, this is not intended to be limiting. In alternative embodiments, other network device resources may be monitored. Examples of resources that may be monitored include but are not limited to non-volatile memory (e.g., CF usage), processor/CPU usage, and the like. In one embodiment, multiple resources may be independently monitored in parallel and appropriate recovery actions initiated upon detecting a problem with a resource. All this may be performed without disrupting network services provided by the network device. The type of recovery action that is initiated may be resource-specific. Further, the test for determining whether a problem exists for a resource may be user-configurable and may depend upon the resource being monitored, the network device configuration, user needs, and the like.

Appropriate recovery actions may be triggered when the availability of a monitored resource falls below some user-configurable threshold. The recovery actions are performed with the goal of providing continuous reliable operation of the network device (i.e., without disrupting services provided by the network device). The recovery actions that are performed may be user-configurable.

As described above, techniques are provided for detecting the presence of a condition related to a resource of the system or device, which could potentially, if not corrected, lead to a disruption in services provided by the system or device. Upon detecting such a condition, the system or device is configured to take one or more recovery actions to remedy the detected condition. In this manner, embodiments of the present invention reduce downtime and increase availability of systems and devices. Various different types of resources may be monitored in this manner including memory-related resources, processing-related resources, and others.

### Examples of Resources

Compact Flash (CF)

In some network devices, the network operating system (NOS) requires certain CF size to be available to support normal operations. For example, certain CF size has to be available to guarantee that the system can boot up successfully. Various situations can occur that may cause the CF to run out of free memory or for the free memory to drop below a threshold required to support normal operations. A common cause of this is creation and storage of a large number of files in the CF. These files may include core dump files created by the operating system, application log files, trace files, panic dumps, etc. created by the NOS, and the like. A user of a network device typically does not have total control over the creation and size of these files and as a result it may inadvertently cause the CF to fill up thereby reducing the size of available free memory. This may cause the CF to accidently run out of free memory, which in turn may cause the network device to enter into an unrecoverable or rolling reboot state.

In one embodiment, RM 114 depicted in FIG. 1 may be configured to monitor the CF, including monitoring partitions (e.g., primary and secondary partitions) of the CF. An error condition may be defined to exist when available CF memory size falls below a preconfigured threshold. The preconfigured threshold may be user-configurable. Accordingly, when CF free memory size is detected to fall below the threshold, then an error/problem condition is indicated and one or more recovery actions may be initiated.

In one embodiment, the recovery actions that are initiated include functions for performing CF cleanup or for freeing CF memory. For example, cleanup functions may be configured to delete certain types of files stored by the CF such as firmware packages, core files, panic dump files, failure data files (e.g., first failure data collection files), NOS application private logs, and the like. Typically, these files include files whose deletion does not impact the working of the device comprising the CF. When CF cleanup function is enabled and triggered, the cleanup may be performed until available CF memory size is above the threshold.

In one embodiment, the cleanup may be performed in the following order until the available CF memory is above the threshold (i.e., until the problem no longer exists):
(1) First, firmware package(s) are deleted;
(2) Next, core files, panic dumps and failure data collection files will be removed based on the age of the files. Older files will be removed first until available CF size is over the threshold setup; and
(3) Next, private logs are removed.

Different command line interfaces (CLIs) may be provided for configuring the functionality of RM 114. For example, CLIs may be provided for setting the threshold that indicates when a recovery action is to be performed. For example, the threshold may be set to a certain memory size such as 10 MB, etc. In one embodiment, the network device may be configured such that the CF monitoring can be turned on or off. CLIs may be provided for enabling/disabling CF monitoring. In one embodiment, the time period for when CF monitoring is performed is also configurable (e.g., may be set to 1 to 60 minutes, with a default of 5 minutes).

System Memory

As described above, in one embodiment, RM 114 may be configured to monitor system physical memory. RM 114 may also monitor NOS daemon memory usage and detect when a low memory (LM) condition exists before an out of memory condition occurs. Various recovery actions/schemes may be provided to recover the network device gracefully, without services disruption, from an LM condition.

There are various ways in which system memory usage can be monitored. In one embodiment, the allocation and deallocation of system memory may be monitored to determine the size of free memory. For example, in order to monitor NOS daemon memory usage, memory allocation and deallocation APIs such as glib memory APIs (malloc( ) calloc( ) realloc( ) and free( )) and trace functions may be tracked and used to determine when memory usage reaches a preconfigured threshold. A trace function provides source code level information for process memory usage analysis.

In another embodiment, for system memory usage, high-watermark and low-watermark memory usage information may be collected. In one embodiment, separate buffers may be created to store the memory (and CPU usage data) information sampled according to a timer. For example, the information may be sampled every minute, every 10 minutes, every hour, etc. In one embodiment, the information that is stored may include memory usage information related to:
System: used memory, free memory, buffers (e.g., number of buffers available), cached memory
Process: VmSize (virtual memory size), VmRSS (physical memory size)

The system memory usage thresholds may be set such that the system is able to gracefully recover from an LM state. For example, in one embodiment, the threshold is setup high enough to ensure the switch has enough memory to take actions like a failover.

In one embodiment, the thresholds may be customized for different platforms and devices and based upon base system memory usage data. In one embodiment, the thresholds may be set as shown in Table B:

TABLE B
Platform Dependent Thresholds

| Plat- | Threshold for Cached Memory | Threshold for system or free |
|---|---|---|
| form | when LM exists | memory when LM exists |
| S1 | 48 | 80 |
| S2 | 14 | 20 |
| S3 | 16 | 20 |
| S4 | 14 | 20 |
| S5 | 52 | 80 |
| S6 | 60 | 80 |
| S7 | 60 | 80 |

As discussed above, various different system memory-related parameters may be monitored and used to determine whether a system memory-related problem condition exists. In one embodiment, usage parameters (TD, TR and TP), as described below, are monitored and their combinations then used to determine when a low system memory condition exists and whether one or more recovery actions are to be triggered. The combination of the TD, TR, and TP thresholds may trigger different error reporting and recovery schemes in different embodiments.

TD: Threshold of daemon VmSize percentage increased from a base value.

TR: Number of times TD is increasing (compare with high water mark).

TP: Number of times that TD stops increasing (equal or less than high water mark).

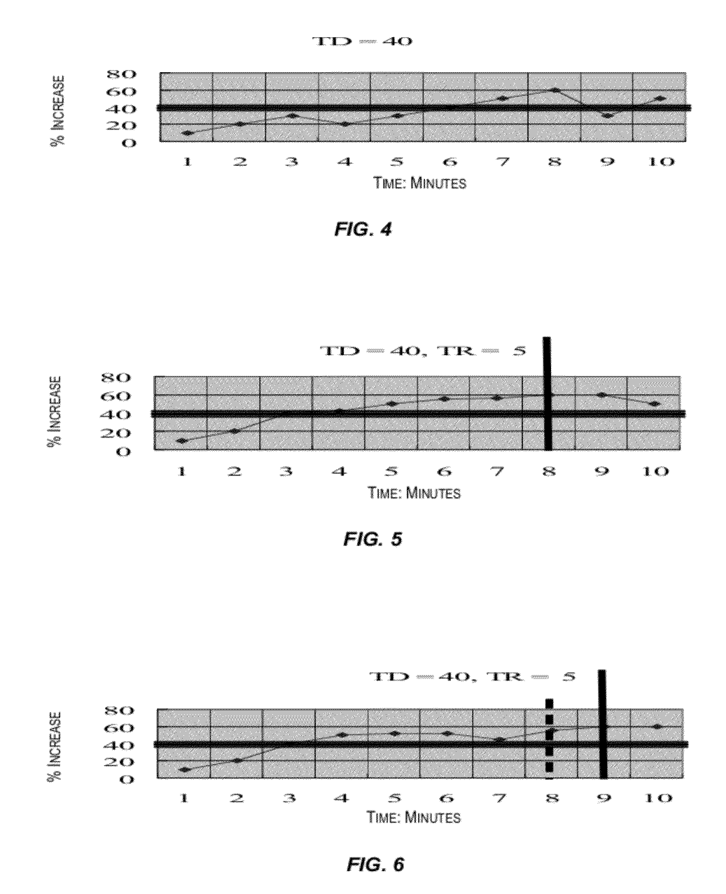

In one embodiment, when the TD threshold is exceeded, then NOS daemon glib (GNU library) memory API trace function may be enabled. The information collected by the trace function may be stored in a trace file. The trace function may be disabled when the TD threshold is no longer exceeded; this is done to minimize impact of the performance of the network device. For example, FIG. 4 shows system memory usage measured and monitored as a percentage over a period of time. In the embodiment shown, the information is sampled at a per minute interval. The TD threshold is set to 40%. In this embodiment, the trace function may be enabled each time the TD threshold is equaled or exceeded (after the reading in 6^{th} minute and 10^{th} minute) and disabled when it falls below 40% (after the 9^{th} minute).

Assuming that the TR threshold is set to 5, a low system memory condition may be indicated and a recovery action initiated when the memory usage triggers TD (i.e., equals or exceeds 40%) and TR is matched or exceeded (i.e., number of times TD increases 5 times). As can be seen from FIG. 5, TD is first triggered (equaled or exceeded) on the 3rd minute and the memory usage continues increasing till the 8^{th} minute, which causes TR to continue accumulating and eventually TR is triggered in the 8^{th} minute. The triggering of the TR indicates a low system memory condition and causes a recovery action to be initiated after the 8^{th} minute reading is taken.

In FIG. 6, TD is first triggered (equaled or exceeded) on the 3rd minute and memory usage continues increasing till the 7^{th} minute, which causes TR to keep accumulating. The memory usage increasing trend stops in the reading taken in the 7^{th} minute and causes TR to stop accumulating. But memory usage resumes increasing (with TR accumulation) in the 8^{th} minute and causes TR to be triggered in the 9^{th} minute.

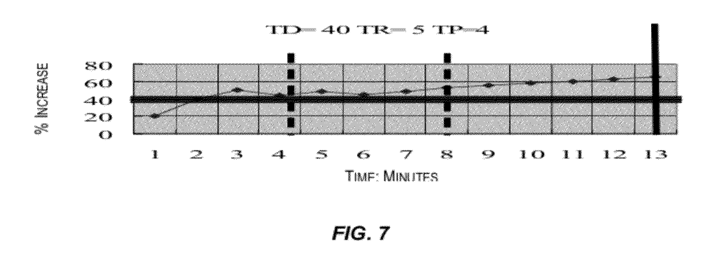

In one embodiment, a low system memory condition may be indicated based upon when TR and TP are triggered. For example, consider the example in FIG. 7. In this example, TD is set to 40%, TR is set to 5, and TP is set to 4. As shown in FIG. 7, the TD threshold is first exceeded in the 3rd minute and TR starts accumulating, but the memory usage stops increasing in the 4^{th} minute, which causes TR accumulation to stop and causes TP to start accumulating. The memory usage is over the TD threshold in the following 4 minutes till the 8^{th} minute but does not exceed the high water mark set in the 3^{rd} minute, so TP keeps accumulating for 4 times. Because TP is set to 4, it causes TP to be triggered and TR to be reset to 0 in the 8^{th} minute. TR starts to again accumulate in 9^{th} minute when memory usage increases to greater than the high water mark set in the 3rd minute. TR is eventually triggered in the 13^{th} minute.

The following Table C shows examples of other thresholds that may be used to track system memory usage.

TABLE C
Examples of thresholds and recovery actions

| Thresholds | Description |
|---|---|
| TS: System memory threshold | Threshold of available minimum physical system memory |
| | to maintain a healthy network device operation. This |
| | threshold may be used to cover memory usage monitoring |
| | not covered by TD and TC thresholds discussed above. |
| | When TS is equaled or exceed, an error may be generated. |
| | A recovery action such as a Failover may be enabled in a |
| | system comprising dual processors (e.g., a dual control |
| | processor system) and triggered upon a “TS” triggering. |
| TC: CLI memory usage threshold | This threshold may be used to set up the limit of CLI |
| | maximum VmSize usage. The CLI may include, for |
| | example, Linux and NOS CLIs. |
| | When TC is equaled or exceeded, an error may be |
| | generated and appropriate recovery actions may be |
| | performed. |
| TT: Threshold of maximum size | When TT is equaled or exceeded, an error may be |
| limit of Linux RAM drive | generated and appropriate recovery actions may be |
| | performed. |

Various CLIs may be provided related to monitoring of system memory. In one embodiment, the network device may be configured such that the system memory monitoring can be turned on or off. CLIs may be provided for enabling/disabling system memory monitoring. The sampling rate of when parameters-related information gathering is performed may also be configured using CLIs. For example, the sampling rate for gathering TD, TR, and TP information may be set up, for example, to a value in the range of 1 to 60 minutes with a default value of 2 minutes. The threshold themselves may be set to different values. In one embodiment, TD is set to a value in the range of 20 to 1000 with a default value of 1000. In one embodiment, TR may be set to a value in the range of 1 to 60 with a default value of 10. In one embodiment, the TP threshold may be set to a value in the range of 1 to 60 with a default value of 5. In one embodiment, the TS threshold may be set to a value in the range of 2M to 100M with a default value of 30M. In one embodiment, the TC threshold may be set to a value in the range of 10M to 1000M with a default value of 800M. In one embodiment, the TT threshold may be set to a value in the range of 20M to 500M with a default value of 200M.

CPU Usage

In one embodiment, the functioning of a CPU may be monitored. CPU-related data may be captured at periodic intervals and stored. For example, the sampled data may be stored in parameter log 130 and used to determine if a problem condition exists. For example, CPU-load data may sampled every minute, every 5 minutes, every 15 minutes, etc. or according to a configured sampling rate.

In one embodiment, the following CPU-usage information may be monitored:
(1) Percentages of total CPU time:

user: Time spent running non-kernel code. (user time, including nice time)

system: Time spent running kernel code. (system time)

idle: Time spent idle.

wait JO: Time spent waiting for IO.
(2) Process CPU data: sleep_avg, and total CPU time the task has used since it started.

Various different problem conditions may be defined, each based upon one or more CPU-related monitored parameters. For example, in one embodiment, a CPU-resource error condition may be reported and recovery actions initiated when all three Linux system CPU load-average values (e.g., 1 minute, 5 minutes 15 minutes) hit a threshold. This threshold may, for example, be in the range of 2-20 time units. In another embodiment, an error condition may be indicated and appropriate recovery actions initiated when the process sleep average percentage and repeat count both exceed certain thresholds. For example, the sleep average threshold may be in the range of 5 to 80 percent with a default value of 50 percent. For example, the repeat count threshold may be in the range of 1 to 60 times with a default value of 10 times.

In one embodiment, the CPU-usage monitoring can be turned on or off. CLIs may be provided for enabling/disabling CPU-usage monitoring.

Although specific embodiments of the invention have been described, various modifications, alterations, alternative constructions, and equivalents are also encompassed within the scope of the invention. For example, while embodiments of the present invention have been described using a network device as an example, this is not intended to limit the scope of the present invention as recited in the claims.

Embodiments of the present invention are not restricted to operation within certain specific data processing environments, but are free to operate within a plurality of data processing environments. Additionally, although embodiments of the present invention have been described using a particular series of transactions and steps, these are not intended to limit the scope of inventive embodiments.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

What is claimed is:

1. A system comprising:
a volatile memory; and
a first processor coupled to the volatile memory;
wherein the first processor is configured to:
reserve a portion of the memory;
monitor a set of one or more parameters related to a resource of the system;
determine, based upon the monitored one or more parameters, if a condition related to the resource exists;
upon determining that the condition exists, release a section of the reserved portion of memory and initiate an action that uses the released section of memory.

2. The system of claim 1 wherein the first processor is configured to:
compare a value associated with a parameter in the set of parameters to a preconfigured threshold; and
determine that the condition exists if the value associated with the parameter in the set of parameters equals or exceeds the preconfigured threshold value.

3. The system of claim 1 wherein the first processor is configured to:
compare a value associated with a parameter in the set of parameters to a preconfigured threshold; and
determine that the condition exists if the value associated with the parameter in the set of parameters equals or is less than the preconfigured threshold value.

4. The system of claim 1 wherein the resource is the volatile memory.

5. The system of claim 4 wherein the set of parameters comprises a parameter indicative of a size of the reserved portion of the volatile memory or a parameter indicative of a size of free memory available in the volatile memory.

6. The system of claim 1 further comprising a non-volatile memory and the resource is the non-volatile memory.

7. The system of claim 1 wherein the resource is the first processor.

8. The system of claim 7 wherein the set of parameters comprises at least one parameter that indicates a usage level of the first processor.

9. The system of claim 1 further comprising a second processor, and wherein:
the first processor is configured to operate in a first mode, wherein a set of functions are performed by the first processor when operating in the first mode;
the second processor is configured to operate in a second mode, wherein the set of functions are not performed by the second processor when operating in the second mode; and
the action initiated by the first processor causes the second processor to operate in the first mode and perform the set of functions and causes the first processor to operate in the second mode and not perform the set of functions.

10. A method comprising:
reserving, by a network device, a portion of volatile memory of the network device;
monitoring, by the network device, a set of one or more parameters related to a resource of the network device;
determining, based upon the monitored one or more parameters, if a condition related to the resource exists; and
upon determining that the condition exists, releasing a section of the reserved portion of memory and initiating, by the network device, an action that uses the released section of memory.

11. The method of claim 10 wherein determining if the condition exists comprises:
comparing, by the network device, a value associated with a parameter in the set of parameters to a preconfigured threshold; and
determining, by the network device, that the condition exists if the value associated with the parameter in the set of parameters equals or exceeds the preconfigured threshold value.

12. The method of claim 10 wherein determining if the condition exists comprises:
comparing, by the network device, a value associated with a parameter in the set of parameters to a preconfigured threshold; and
determining, by the network device, that the condition exists if the value associated with the parameter in the set of parameters equals or is less than the preconfigured threshold value.

13. The method of claim 10 wherein the resource is the volatile memory.

14. The method of claim 13 wherein the set of parameters comprises a parameter indicative of a size of the reserved portion of the volatile memory or a parameter indicative of a size of free memory available in the volatile memory.

15. The method of claim 10 wherein monitoring the set of parameters comprises monitoring the set of parameters related to a non-volatile memory of the network device.

16. The method of claim 10 wherein monitoring the set of parameters comprises monitoring the set of parameters related to a first processor of the network device.

17. The method of claim 16 wherein the set of parameters comprises at least one parameter that indicates a usage level of the first processor.

18. The method of claim 10 further comprising:
operating the first processor in a first mode, wherein a set of functions are performed by the first processor when operating in the first mode; and
operating a second processor of the network device in a second mode, wherein the set of functions are not performed by the second processor when operating in the second mode;
wherein initiating the action comprises causing the second processor to operate in the first mode and perform the set of functions and causing the first processor to operate in the second mode and not perform the set of functions.

19. A device comprising:
a resource; and
a processor configured to:
upon detecting a condition related to the resource:
release a portion of memory; and
use the released portion of memory to execute an action that remedies the condition.

20. The device of claim 19 wherein the resource is a memory-related resource or a processing-related resource of the device.
